(19) United States
(12) Patent Application Publication
(10) Pub. No.: US 2021/0009302 A1
(43) Pub. Date: Jan. 14, 2021

(54) Child-Resistant Cap and a Combination of Child-Resistant Cap and Ergonomic Prescription Pill Bottle

(71) Applicant: Sun Hyun Kim, Toronto (CA)

(72) Inventor: Sun Hyun Kim, Toronto (CA)

(21) Appl. No.: 16/510,856

(22) Filed: Jul. 12, 2019

(51) Int. Cl. B65D 1/02; B65D 50/00; A61J 1/03

(52) U.S. Cl. CPC B65D 1/023; B65D 2501/0081; A61J 1/03; B65D 50/00

(57) ABSTRACT

The present invention relates to the application of elliptical cylindrical bottles for dispensing prescription medications, such as tablets and capsules. The elliptical cylindrical shape offers ergonomic grip compare to the circular cylindrical shape currently used. The present invention of bottles are easier to grip and reduce hand-fatigue. In addition, these bottles offer a relatively planar surfaces for prescription and auxiliary labels, which eliminate the action of rotating the bottle back-and-forth to read the labels as with the current circular cylindrical prescription pill vials. Secondly, some prescription pill vials have caps with a small grip area that renders the operation of the cap difficult. The present invention of the cap is ergonomic, has a relatively wider grip area, and has a novel child-resistant closure system comprising of projections on the cap and grooves on the neck of the bottle, which are easier to operate.

### CROSS REFERENCE

| Publication No. | Priority date | Publication date | Assignee | Title |
|---|---|---|---|---|
| US327225A | | 1885 Sep. 29 | | Stand or casing |
| | | | | for bottles |
| US942141A | 1909 Jan. 5 | 1909 Dec. 7 | American | Jar |
| | | | Stopper | and bottle |
| | | | Company | closure. |
| US3072276A | 1960 Apr. 21 | 1963 Jan. 8 | Celluplastics | Spring member for |
| | | | Inc | tamper proof vial |
| U.S. Pat. No. 2,987,207 | 1960 Oct. 3 | 1961 Jun. 6 | Stevoff George | Safety container and |
| | | | | locking cap therefor |
| US3155259A | 1963 Dec. 26 | 1963 Dec. 26 | Scheurman | Safety medicine |
| | | | Abbie | bottle and cap |
| US3344942A | 1966 Apr. 5 | 1967 Oct. 3 | Hedgewick | Safety cap |
| | | | Peter | and container |
| US340795A | 1966 Aug. 18 | 1968 Oct. 29 | Millis | Container and closure |
| | | | Alexander | closure therefore |
| US3435975A | 1967 Oct. 30 | 1969 Apr. 1 | Tamper Proof | Safety closure |
| | | | Tops Ind Ltd | |
| US3880313A | 1968 Mar. 4 | 1975 Apr. 29 | Edward G | Safety cap |
| | | | Akers | and container |
| US3557985A | 1969 Jun. 2 | 1971 Jan. 26 | Marcel Louis | Tamper-proof plastic |
| | | | St Denis | closure cap and |
| | | | | method of making |
| | | | | same |
| US3450290A | | 1969 Jun. 17 | Lloyd S Turner | Safety closure |
| | | | | for a container |
| US3608764A | 1969 Sep. 5 | 1971 Sep. 28 | Reflex Corp | Safety closure |
| | | | Canada Ltd | assembly |
| US3612324A | 1969 Sep. 25 | 1971 Oct. 12 | Dell M Malick | Safety cap and |
| | | | | container neck |
| | | | | construction |
| US3613928A | 1970 Dec. 28 | 1971 Oct. 19 | Eyelet | Safety-closure device |
| | | | Specialty Co | |
| US3703974A | 1971 Mar. 8 | 1972 Nov. 28 | Leo M Boxer | Safety cap |
| US3951289A | 1971 Mar. 22 | 1976 Apr. 20 | Eyelet | Safety-closure |
| | | | Specialty Co., | device |
| | | | Inc. | |
| CA949496A | 1971 Jul. 26 | 1974 Jun. 18 | Anchor Cap | Safety closure |
| | | | And Closure | and package |
| | | | Corporation Of | |
| | | | Canada | |
| US3716161A | | 1973 Feb. 13 | R Julian | Safety closure for a |
| | | | P Gach | medicine bottle or the like |
| US4134513A | | 1979 Jan. 16 | | Child-resistant |
| | | | | safety closure |
| US3880313A | | 1975 Apr. 29 | | Safety cap |
| | | | | and container |
| US4279355A | 1980 Apr. 11 | 1981 Jul. 21 | Rite | Twist-lock container |
| | | | Autotronics | |
| | | | Corporation | |
| US5411161A | 1994 Aug. 19 | 1995 May 2 | Fish, Jr.; | Container having a |
| | | | Milton L. | twist-locking cover |
| USD485185S1 | 2001 Jun. 29 | 2004 Jan. 13 | Gianni Versace SpA | Cosmetics bottle |
| US6378713B2 | | 2002 Apr. 30 | | Safety closure |
| | | | | and container |
| USD511461S1 | 2003 Dec. 9 | 2005 Nov. 15 | SGD SA | Bottle |
| USD550564S1 | 2005 Mar. 4 | 2007 Sep. 11 | Partida Tequila LLC | Bottle |
| USD696957S1 | 2011 Jul. 29 | 2014 Jan. 7 | Stella McCartney Ltd | Bottle |
| USD691894S1 | 2012 Aug. 31 | 2013 Oct. 22 | Spirit Works | Bottle |
| | | | Distillery LLC | |
| USD714654S1 | 2013 Apr. 19 | 2014 Oct. 7 | Valentino SpA | Container for perfumes |
| USD799976S1 | 2016 Apr. 11 | 2017 Oct. 17 | Bottega Veneta SA | Perfume bottle |

### STATEMENT OF FEDERALLY SPONSORED RESEARCH OR DEVELOPMENT

Not Applicable

### THE NAMES OF THE PARTIES TO A JOINT RESEARCH AGREEMENT

Not Applicable

### BACKGROUND OF THE INVENTION

Currently, prescription medications, such as tablets and capsules, are dispensed by pharmacies in circular, cylindrically-shaped prescription medication vials, with the prescription and auxiliary labels affixed wrapped around the barrel of the vial. The vials were first introduced in the 1950's and they have not changed since. Many advancements in life have been made since 1950's except for the prescription medication vials. There are a number of disadvantages with the vials and with some of the caps currently in use, which the present invention concept offers to address.

Firstly, the vials are not ergonomic. In order to grip them, there is a considerable bending of the fingers. This action can be difficult and even painful for people with reduced manual dexterity due to musculoskeletal diseases, such as arthritis. Secondly, in order to read the instructions on the labels affixed on them, one has to rotate the vials back-and-forth, which is not ideal for reading the instructions on the labels. Lastly, some of the caps have a narrow grip area, which can make removing the cap difficult, again, especially for those with reduced manual dexterity, such as arthritis. Furthermore, some of the child-resistant caps are not easy to operate and are complex, which can make the manufacturing of the cap expensive.

The aging population is increasing. Generally, incidences of musculoskeletal diseases increase with age, as well as other medical conditions, such as high blood pressure, diabetes, high cholesterol, etc. As a result, the number of people requiring prescription medications, as well as the number of medications taken by each person will increase with time. The use of prescription medication vials already are an integral part of some peoples' lives and will become for many more. Therefore, it is important to have pharmacy pill bottles and child-resistant caps that are ergonomic and easy to use and bottles that offer a relatively easy reading platform for the labels. The present invention aims to have a positive impact on the lives of many people who have to take prescription medications daily.

### BRIEF SUMMARY OF THE INVENTION

Embodiments of the present invention are a plurality of a generally elliptical cylindrically-shaped pharmacy pill bottle. The front and the back of the bottle are slightly curved, which are connected by curved side portions, forming the generally elliptically shaped bottle. At the top-center of the bottle is a wide and circular cylindrically-shaped neck that is connected via the shoulder and at the upper end of the neck is a mouth with an opening into the chamber of the bottle. The neck has novel closure system to removeabley receive a cap to cover the mouth opening.

Another embodiments of the present invention are two J-shaped grooves located diametrically opposed on the outward side of the neck of the bottle, where the longer vertical groove opens at the rim of the neck. It is understood the neck may have a plurality of J-shaped grooves. To cover the mouth opening of the bottle with a cap, there are two projections located on the inner surface of the cap diametrically opposed, which engage first with the long vertical grooves. It is understood the cap may have a plurality of projections on the inner surface. Once the projections engage with the grooves that open at the rim of the neck, the cap is pushed axially along the grooves. When the projections reach the bottom portion of the J-grooves, the cap is rotated clockwise which causes the projections to glide along the curvature of the grooves. The cap is then pulled axially into the shorter vertical grooves and into a rest position. The cap is now in a locked position. The cap is removed from the neck by pressing the cap axially against the neck which releases the projections from the shorter vertical grooves, then by turning the cap counter-clockwise causing the projections to glide along the curved grooves, and then by pulling the cap axially along the longer vertical grooves and then off the neck. The grooves, in the shape of the capital letter J, on the neck are easier to operate and offer novel child-resistant closure system.

Another embodiments of the present invention are a plurality of a cap that is comprised of two parts, a cap body and a resilient disc that is fitted inside the upper end of the cap body. The top portion of the cap body is wider than the bottom portion, thus having the appearance of an upside-down, truncated, circular cone, and offers a relatively wide grip area. Alternatively, the cap may have the traditional circular, cylindrical shape. On the inner surface of the lower part of the cap body are two small projections located diametrically opposed. It is understood the cap may have a plurality of projections on the inner surface. The projections engage with the grooves on the neck of the bottle which comprise the closure system. The resilient disc located inside the top end of the cap body permits the cap to be pressed axially against the neck and release the projections from the shorter vertical grooves, that is, from the locked position, and allow the cap to be removed from the neck.

The intended use of the present invention is for dispensing prescription medications, such as tablets and capsules, by pharmacies. The present invention of child-resistant cap may be applied to a bottle and other container system. The present invention of child-resistant cap is easier to operate than the comparable push-down-and-turn caps. The present invention of prescription pill bottle offers ergonomic grip compared to the traditional prescription pill vial, reducing hand-fatigue and thus improving the quality of life of those who have to use a number of prescription pill vials daily. In addition, the present invention of prescription pill bottle offers a relatively planar surfaces on the front and the back for the prescription and auxiliary labels to be affixed, allowing easier reading of the labels.

### BRIEF DESCRIPTIONS OF THE SEVERAL VIEWS OF THE DRAWING

In drawings, embodiments of the present invention is described as follows:

FIG. 1 is a perspective view of a plurality of generally elliptical cylindrically-shaped prescription pill bottle, one with the upside-down, truncated, cylindrical cone shaped cap on and another with the traditional circular cylindrical cap on, according to an embodiment of the invention;

FIG. 2 is a front view thereof of the bottle with caps separate illustrating the J-shaped groove on one side, according to an embodiment of the invention;

FIG. 3 is a side view thereof of a plurality of bottles without a cap on, according to an embodiment of the invention;

FIG. 4 is a top view thereof of the bottle with caps separate illustrating the top view of the two grooves located diametrically opposite of each other that open at the rim of the neck, according to an embodiment of the invention;

FIG. 5 is a bottom view thereof of the bottle without a cap on, according to an embodiment of the invention;

FIG. 6 is a perspective view thereof of the neck of the bottle illustrating the J-shaped groove on one side of the neck, according to an embodiment of the invention;

FIG. 7 is a perspective view thereof of a cap illustrating one of the projections on the inner surface of the cap, according to an embodiment of the invention;

FIG. 8 is a bottom view thereof of the cap illustrating the two projections located diametrically opposite side of each other and a resilient disc insert, according to an embodiment of the invention; and

FIG. 9 is an exploded view of a cap, a resilient disc insert and the bottle, according to an embodiment of the invention.

### DETAILED DESCRIPTION OF THE INVENTION

Embodiments of the present invention pertain to a plurality of prescription pill bottles that are generally elliptical cylindrically-shaped body. The shape conforms to the contour of the hand at relaxed state. As a result, there is less bending of the finger, hand, and forearm muscles when gripping the bottles, thereby reducing strain on the said muscles and hand-fatigue. The bottle has a relatively wide and circular cylindrically-shaped neck and a mouth for dispensing tablets, capsules and such. The neck is grooved, as described below, to removably receive a cap to cover the mouth opening. The cap offers a relatively wider grip area than some of the traditional cap, for easier operation.

Moreover, the new bottle offers a relatively wider and planar surfaces on the front and the back portions for the prescription and auxiliary labels, which will allow easier reading of the labels and eliminate the need to rotate the bottle back-and-forth to read them. The new bottle does not require any changes to the existing labelling system used by pharmacies, which will make the transition from the traditional vials efficient.

In drawings, the following figures illustrate embodiments of the present invention:

In FIG. 1, in one embodiment, pharmacy bottle system 10 illustrates a perspective view of a plurality of prescription pill bottle 12 that is generally elliptical cylindrical in shape with a wide, circular cylindrical neck 14, for tablets, capsules, and such. Bottle 12 comprises a container 16, which comprises a front portion 18 that is slightly curved, but relatively planar and a back portion 20 that is slightly curved, but relatively planar—where prescription and auxiliary labels are affixed—connected by a side portion 22 that is curved to form a generally elliptical, cylindrical shape. The cap 24a is generally shaped of a truncated, upside down cone. Alternatively, it is shaped circular cylindrical, similar to the traditional cap 24b.

FIG. 2 is a front view thereof of the prescription pill bottle 12, according to an embodiment of the invention. Bottle 12 comprises a container 16, which comprises shoulder 26, and a circular cylindrical neck 28 in the center of the shoulder. A circular mouth 30 is located at the upper end of the neck 28. The mouth 30 opens 32 to inside of the container 16. The neck 28 is grooved 34 to removeably receive a cap 24a/b to cover the opening 32 in the mouth 30.

FIG. 3 is a side view thereof of a plurality of prescription pill bottle 12 illustrating a wide neck 14, according to an embodiment of the invention.

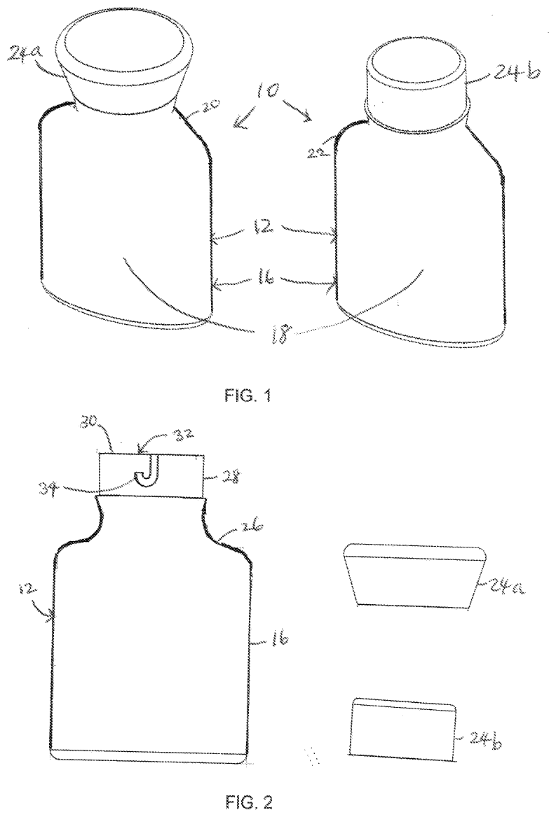

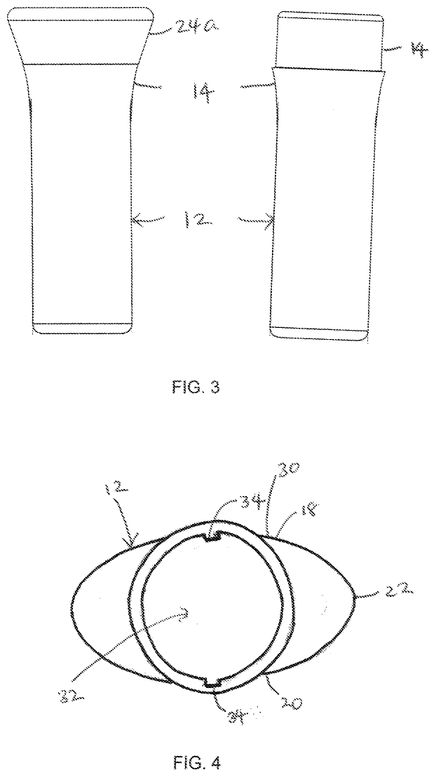

FIG. 4 is a top view thereof of the prescription pill bottle 12, according to an embodiment of the invention, illustrating mouth 30 and opening 32, encompassing the front 18 and the back portion 20 of the container 12. The curved side portions 22 connect the slightly curved, but relatively planar front portion 18 to the slightly curved, but relatively planar back portion 20 forming a generally elliptical shape. The neck 14 has two grooves 34 that engage with a cap 24a/b to form a child-resistant closure system.

FIG. 5 is a bottom view thereof of the prescription pill bottle 12, without a cap on, according to an embodiment of the invention, illustrating the bottom 36 and the neck 14.

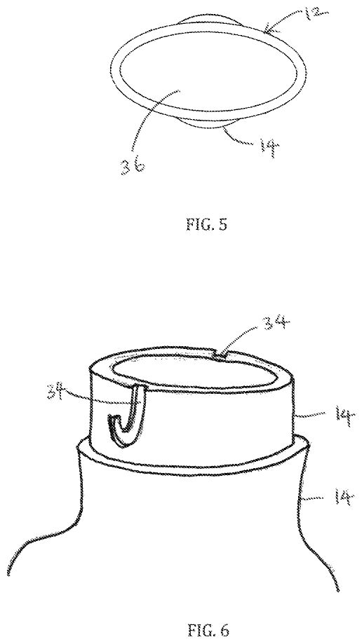

FIG. 6 is a perspective view of the neck 14, according to an embodiment of the invention, illustrating the grooves 34.

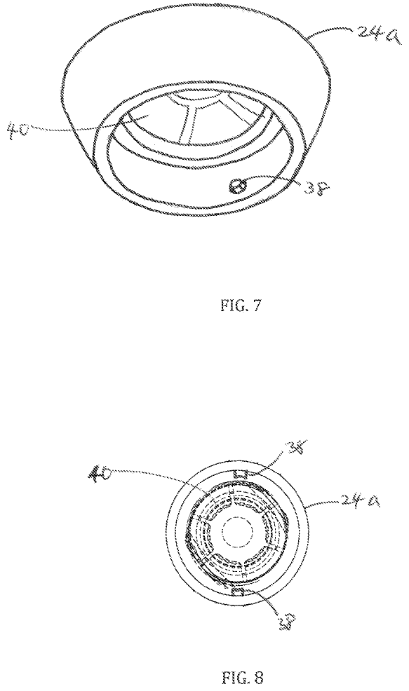

FIG. 7 is a perspective view of a cap 24a, according to an embodiment of the invention, illustrating one of the two projections 38 located diametrically opposite of each other on the inner surface of the cap body near the bottom of the cap body. In the upper end of the cap body is a resilient disc member 40.

FIG. 8 is a bottom view thereof of a cap 24b, according to an embodiment of the invention, illustrating the two inward projections 38 located on the inner surface of the cap body diametrically opposite of each other and a resilient disc member 40 in the upper end of the cap body.

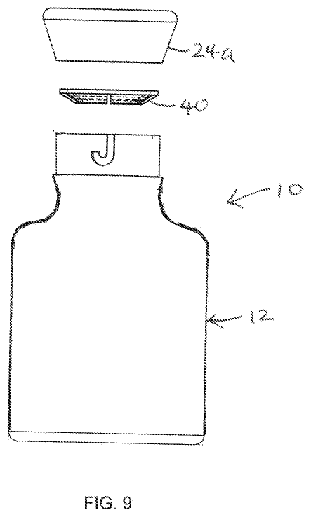

FIG. 9 is an exploded view of a cap 24a, a resilient disc member 40 for the cap body 24a and the prescription pill bottle 12, according to an embodiment of the invention, illustrating the assembly of the pharmacy bottle system 10.

While specific embodiments have been illustrated and described herein, scope of the present invention encompasses a plurality of prescription pill bottle that are generally elliptical cylindrical in shape, a plurality of cap that has a relatively wide grip area that has the shape of an upside down, truncated cone and, alternatively, circular cylinder, and a child-resistant, closure system comprising of grooves on the outward side of the neck of the bottle and projections on the inner side of the cap body. The shapes of the bottle and the cap are not new per se. However, their application to prescription pill bottle and cap is. The shape of the grooves on the neck, the J-shape, is new and offer easier and smoother operation of cap closure.

Embodiments of the present invention in which an exclusive property or privilege is claimed are defined as follows:

1. A pharmacy bottle comprising:
a container including:
a generally elliptical cylindrically-shaped body defining a chamber therein;

2. The pharmacy bottle of claim 1 wherein the container comprises an opening disposed at the top center of the body via shoulder and neck, which is adapted to removably receive a cap to cover the opening;

3. The pharmacy bottle of claim 2 wherein the neck is circular cylindrical in shape and has grooves to engage with projections located on the inner surface of the cap and guide the cap to slide along the grooves to cover the opening on the bottle;

4. A plurality of cap with a relatively wide grip area comprised of cap body and a resilient disc insert, which is located in the upper end of the cap body;

5. The cap of claim 4 wherein there are projections on the inner surface of the cap body, which engage with the grooves on the neck of the bottle and glide along the grooves to cover the opening on the bottle;

6. The cap of claim 5 wherein the cap body is in the shape of an upside down, truncated cone; and

7. The cap of claim 5 wherein, alternatively, the cap body is in the shape of circular cylinder.
